(19) United States
(12) Patent Application Publication
(10) Pub. No.: US 2004/0050260 A1
(43) Pub. Date: Mar. 18, 2004

(54) Method and unit for the transport of rice

(76) Inventors: Toshiaki Tanaka, Kanagawa (JP); Jens Oeding, Wolfenbuttel (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/363,035

(22) PCT Filed: Aug. 17, 2001
(86) PCT No.: PCT/CH01/00504

(30) Foreign Application Priority Data
Aug. 28, 2000 (DE) 100 42 135.0

(51) Int. Cl. B02B 1/04; B02B 3/12

(52) U.S. Cl. 99/486; 99/519

(57) ABSTRACT

The invention relates to a method and unit for the transport of rice, in particular to the continuous pneumatic transport X of rice in a rice mill. Sensors for the measurement of the humidity and the temperature of the transporting air are arranged in the transport lines and the actual value can be adjusted to match a set value by means of suitable regulators.

The present invention relates to a method and a unit for transporting rice, in particular for the pneumatic transport of rice in rice mills.

The pneumatic transporting of grain in silos and grain mills has been known for some time. Dry bulk goods and bulk goods occurring in large quantities in granular and pulverulent form can be transported to advantage pneumatically. In the case of wheat transport good sanitation conditions are an added benefit.

DE-U-8717367 discloses a transport pipe for bulk goods transport which has projections of less than 1 mm in height directed into the interior of the pipe for preventing angel hair from occurring. With similar solutions, as for example in DE-OS 2008989, deposits on walls are to be prevented.

DE-OS 3026001 discloses a rice mill with pneumatic rice grain transporters and pneumatic sifters, whereby the material in the latter is decelerated and abrasion occurs. Adjustable plate devices with curved plates are provided with an abrasion coating. These can be arranged in cascades for the purpose of removing air from the rice grains. Such deceleration caused by this curved arrangement is meant to prevent or minimise breakage of transported rice grains and is incorporated into each processing step.

Pneumatic sifting and transport devices are provided for principal products and by-products and the previously assumed risk of breakage of the rice grains by pneumatic transport should be eliminated by the rice grains being prevented from striking hard metal surfaces. The density of the grain flow can also be altered by the adjustability of the curved plates.

The object of the invention is now to create a method for transporting rice, in particular for pneumatic transport, by which the transport of rice itself can be designed to be safer and simpler. This task is solved by means of the characterising features of the principal claim, while advantageous embodiments are given in the sub-claims.

Another object of the invention is to develop a unit for transporting rice, in particular for pneumatic transport of rice.

The knowledge of the invention is that the risk of breakage can be further prevented by adjusting or optimising the transport speed in the supply lines.

Linings are preferably to be avoided and pipes should be polished on the inside. The transport speed is to be reduced at specific points by inclusion of conical pipe sections. The humidity and temperature of the transporting air are also to be regulated, or at least be controlled.

Under normal circumstances the transport medium is air, but an inert gas or similar can also be utilised to protect the rice aroma for example (e.g. with Japanese white rice) or to effect a reduction in the surface content. It is also possible to filter the transport medium, air in particular.

To prevent grain from being broken up the product can be fed to the gas flow using specific feed devices, such as transfer tubes, for example.

The invention will now be described in greater detail hereinbelow with reference to an embodiment.

In a rice mill, whose product is transported fully pneumatically, the temperature and humidity of the transporting air are detected in relevant sections of the transporting pipe branches by means of sensors which are arranged in the region of the inner wall of the transport pipes. The actual data are forwarded to a standard control unit, compared to predetermined set values and subsequently regulated in favour of the set values. This can include cooling or heating of transporting air, or humidifying or dehumidifying of the transporting air (also of the transport material, if required).

The transporting pipe branches and the nozzles leading to or from the individual machines and processing apparatus are configured such that the rice is fed continuously due to shock-free junctions. Where required the transport speed of the rice is optimised by use of conical junctions, that is, increased or decreased according to the direction of assembly.

1. A method for transporting rice, in particular by means of continuous pneumatic transport of rice in a rice mill, characterised in that the temperature and the moisture of the transporting air is measured in the transporting pipe branch, and in that these actual values are compared to predetermined set values and are then regulated or adjusted in favour of the set value.

2. The method as claimed in claim 1, characterised in that the transport speed in the transporting pipe branch can be adjusted to an optimum value.

3. The method as claimed in any one of claims 1 or 2, characterised in that the transport flow is even and unimpeded.

4. A unit for transporting rice, in particular for continuous pneumatic transport of rice in a rice mill having transporting pipe branches connected between the individual processing devices, characterised in that branch sensors are provided for measuring the humidity and the temperature.

5. The unit as claimed in claim 4, characterised in that the sensors are connected via control units to regulators for measuring temperature and humidity of the transporting air.

6. The unit as claimed in claim 4, characterised in that the transport lines of the pipe branches and nozzles leading to processing devices are polished on the interior.

7. The unit as claimed in any one of claims 4 or 6, characterised in that at least one transport line is designed with a conical interior.

8. The unit as claimed in any one of claims 4, 6 or 7, characterised in that the transport pipes and/or nozzles are connected to one another without lining.
